(19) United States
(12) Patent Application Publication
(10) Pub. No.: US 2005/0249136 A1
(43) Pub. Date: Nov. 10, 2005

(54) Dynamic assignment of station addresses transmitted over shared-communications channels

(76) Inventors: Michael Andrew Fischer, San Antonio, TX (US); Timothy Gordon Godfrey, Overland Park, KS (US)

Correspondence Address: DEMONT & BREYER, LLC, SUITE 250, 100 COMMONS WAY, HOLMDEL, NJ, 07733, US

(21) Appl. No.: 10/621,557

(22) Filed: Jul. 17, 2003

Related U.S. Application Data
(60) Provisional application No. 60/396,691, filed on Jul. 17, 2002.

(51) Int. Cl. H04B 7/00

(52) U.S. Cl. 370/310

(57) ABSTRACT

A technique is disclosed for assigning addresses to stations in a local area network without some of the costs and disadvantages for doing so in the prior art. In particular, the illustrative embodiment ensures that unique addresses are assigned to the stations in a local area network in such a way that the broadcasting of the address does not reveal the identity of the station. Furthermore, the illustrative embodiment of the present invention accomplishes the dynamic address generation without modification to the frame formats or low-level medium access control protocol. The present invention is particularly useful for stations that wish to associate with a local area network and request services from that network.

### CROSS-REFERENCE TO RELATED APPLICATIONS

This application claims the benefit of U.S. Provisional Patent Application Ser. No. 60/396,691, entitled “Distributed, Dynamic Assignment of Station MAC Addresses for (Wireless) LAN,” filed on Jul. 17, 2002 (Attorney Docket: 1938-8-2), which is incorporated by reference.

### FIELD OF THE INVENTION

The present invention relates to telecommunications in general, and, more particularly, to local area networks.

### BACKGROUND OF THE INVENTION

FIG. 1 depicts a schematic diagram of local area network 100 in the prior art. Network 100 comprises shared-communications channel 102 and telecommunication stations 101-1 through 101-K, wherein K is a positive integer. Each of stations 101-1 through 101-K are typically associated with host computers and other devices (e.g., printer servers, email servers, file servers, etc.) to enable them to communicate with each other.

Each of stations 101-1 through 101-K is associated with a unique address so that transmissions from one station can be unambiguously directed or “addressed” to another. If each station is not associated with a unique address, it might be difficult or impossible for a station to discern which transmissions are intended for it and which are not. Therefore, it is of particular importance to the designers and operators of networks to ensure that each station in the network is associated with a unique address.

There are several techniques in the prior art for associating unique addresses with stations in a network.

In accordance with a first technique, the association of station addresses is performed manually. For example, a person associates an address with a station by setting a plurality of dual-inline-package (“DIP”) switches on the station to that address. This technique is advantageous because it is inexpensive and simple to implement, but is disadvantageous because it is labor-intensive and prone to human error.

In accordance with a second technique, each time a station tries to associate with a network, the station generates a random address and provisionally associates itself with it. To ensure that the address is unique, the station transmits a number of inquiry messages to that address. If none of the inquiries yields a response within a reasonable amount of time, the station can reasonably presume that its provisional address is in fact unique and can be made nonprovisional. In contrast, if any of the inquiries do yield a response, then the station will know that its provisional address is already associated with another station. In this case, the station will repeat the process of generating and checking for uniqueness another address until a unique address was found.

The advantage of the second technique is that it does not involve human involvement, and, therefore, is not labor intensive or subject to human error. The disadvantage of the second technique is that it works only within a single network (i.e., it does not assign unique addresses to stations in different but interconnected networks).

In accordance with a third technique, each station is assigned a permanent and globally-unique address when the station is fabricated at the factory. The advantage of the third technique is that duplicate addresses are extremely unlikely to occur. The disadvantage of the third technique is that the location of a mobile station can be tracked because it is always broadcasting its globally-unique address, and this is true even if the payload is encrypted.

Therefore, the need exists for a technique for assigning addresses to stations in a network that ensures that the addresses will be unique and that does readily not reveal the identity of the station.

### SUMMARY OF THE INVENTION

The present invention provides a technique for assigning addresses to stations in a local area network without some of the costs and disadvantages for doing so in the prior art. In particular, the illustrative embodiment ensures that unique addresses are assigned to the stations in a local area network in such a way that the broadcasting of the address does not readily reveal the identity of the station. Furthermore, the illustrative embodiment of the present invention is backward compatible with some existing protocols in that it does not require a modification to the frame formats or medium access control protocol. The present invention is particularly useful for stations that wish to associate with a local area network and request services from that network.

An illustrative embodiment of the present invention comprises: receiving a first frame from a station in a local area network, wherein said first frame uses a first address as the medium access control address for said station in said local area network; assigning an association identifier to said station; transmitting a second frame to said station via said local area network, wherein said second frame comprises said association identifier and uses said first address as the medium access control address for said station in said local area network; and receiving a third frame from said station via said local area network, wherein said third frame uses a second address, rather than said first address, as the medium access control address for said station in said local area network; wherein said second address is a combination of (1) a portion of said first address and (2) at least a portion of said association identifier.

### BRIEF DESCRIPTION OF THE DRAWINGS

FIG. 1 depicts a schematic diagram of wireless local area network 100 in the prior art.

FIG. 2 depicts a schematic diagram of a portion of local area network 200 in accordance with the illustrative embodiment of the present invention.

FIG. 3 depicts a block diagram of the salient components of access point 201 in accordance with the illustrative embodiment of the present invention.

FIG. 4 depicts a block diagram of the salient components of station 202-i in accordance with the illustrative embodiment of the present invention.

FIG. 5 depicts a flowchart of the salient tasks performed by access point 201 in accordance with the first illustrative embodiment of the present invention.

FIG. 6 depicts a schematic diagram of an association request frame in accordance with the illustrative embodiment of the present invention.

FIG. 7 depicts a schematic diagram of an association response frame in accordance with the illustrative embodiment of the present invention.

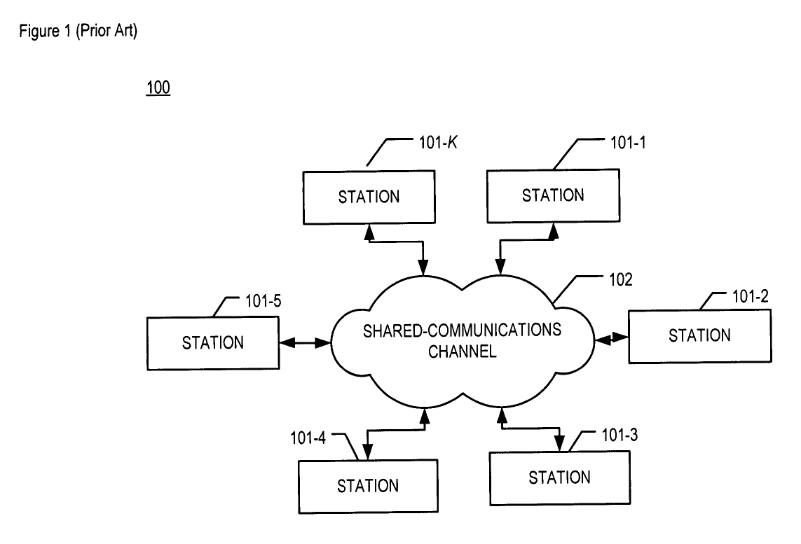

### DETAILED DESCRIPTION

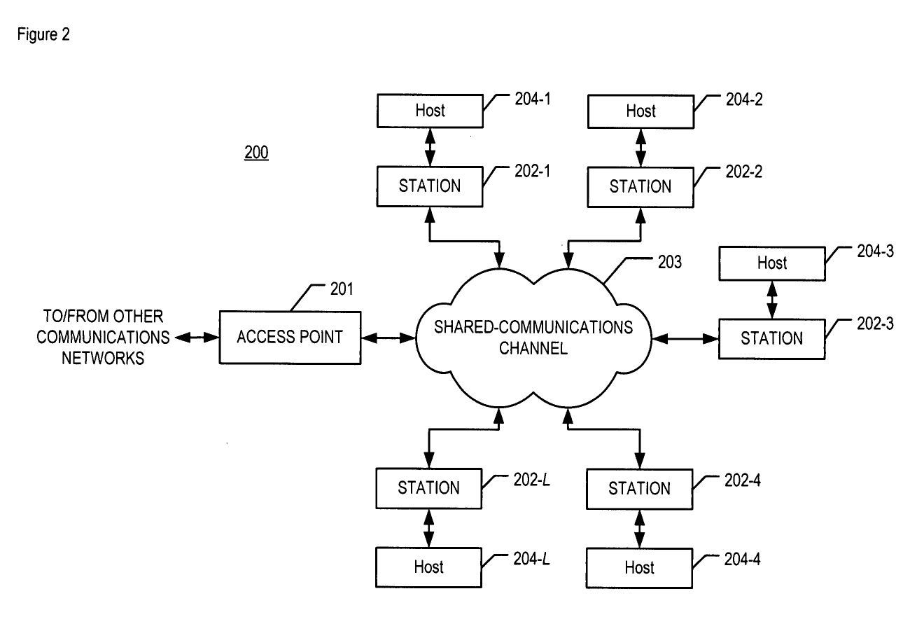

FIG. 2 depicts a schematic diagram of local area network 200 in accordance with the illustrative embodiment of the present invention. Network 200 operates in accordance with the IEEE 802.11 set of protocols and comprises access point 201, stations 202-1 through 202-L, wherein L is a positive integer, host computers 204-1 through 202-L, and wireless shared-communications channel 203, interconnected as shown.

It will be clear to those skilled in the art, after reading this specification, how to make and use embodiments of the present invention that operate in accordance with other protocols. Furthermore, it will be clear to those skilled in the art, after reading this specification, how to make and use embodiments of the present invention that use a wireline or tangible shared-communications channel.

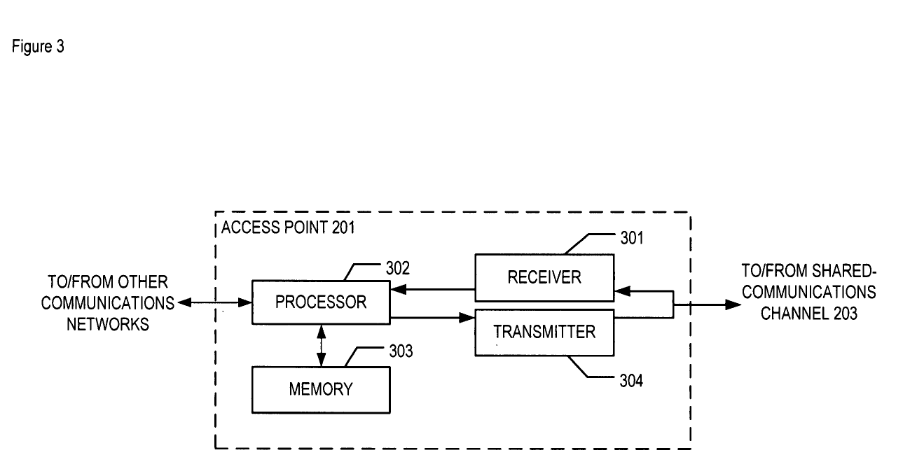

Access point 201 enables stations 202-1 through 202-L within local area network 200 to communicate with devices in other communications networks. Furthermore, stations 202-1 through 202-L communicate with each other through access point 201, because access point 201 coordinates the communications on local area network 200. The salient details of access point 201 are described below and with respect to FIG. 3.

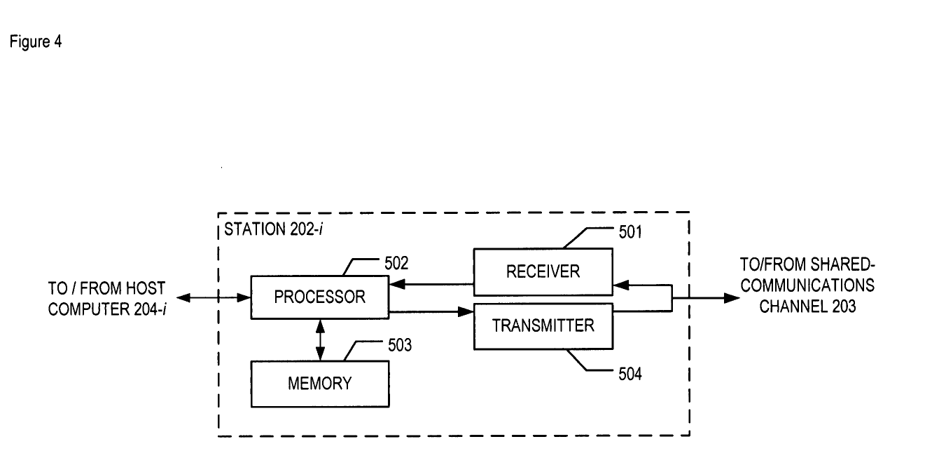

Station 202-i, for i=1 through L, comprises the radios that enable host 204-i to communicate via shared-communications channel 203. Station 202-i is capable of receiving data blocks from host computer 204-i and transmitting over shared-communications channel 203 data frames comprising the data received from host computer 204-i. Station 202-i is also capable of receiving data frames from shared communications channel 203 and sending to host computer 204-i data blocks comprising data from the data frames. It will be clear to those skilled in the art, after reading this specification, how to make and use station 202-i. The salient details for station 202-i are described below and with respect to FIG. 4.

Host computer 204-i is capable of generating data blocks and transmitting those data blocks to station 202-i. Host computer 204-i is also capable of receiving data blocks from station 202-i and of processing and using the data contained within those data blocks. Host computer 204-i can be, for example, a desktop or a laptop computer that uses local area network 200 to communicate with other hosts and devices via access point 201. It will be clear to those skilled in the art how to make and use host computer 204-i.

FIG. 3 depicts a block diagram of the salient components of access point 201 in accordance with the illustrative embodiment of the present invention. Access point 201 comprises receiver 301, processor 302, memory 303, and transmitter 304, interconnected as shown.

Receiver 301 is a circuit that is capable of receiving frames from shared communications channel 203, in well-known fashion, and of forwarding them to processor 302. It will be clear to those skilled in the art how to make and use receiver 301.

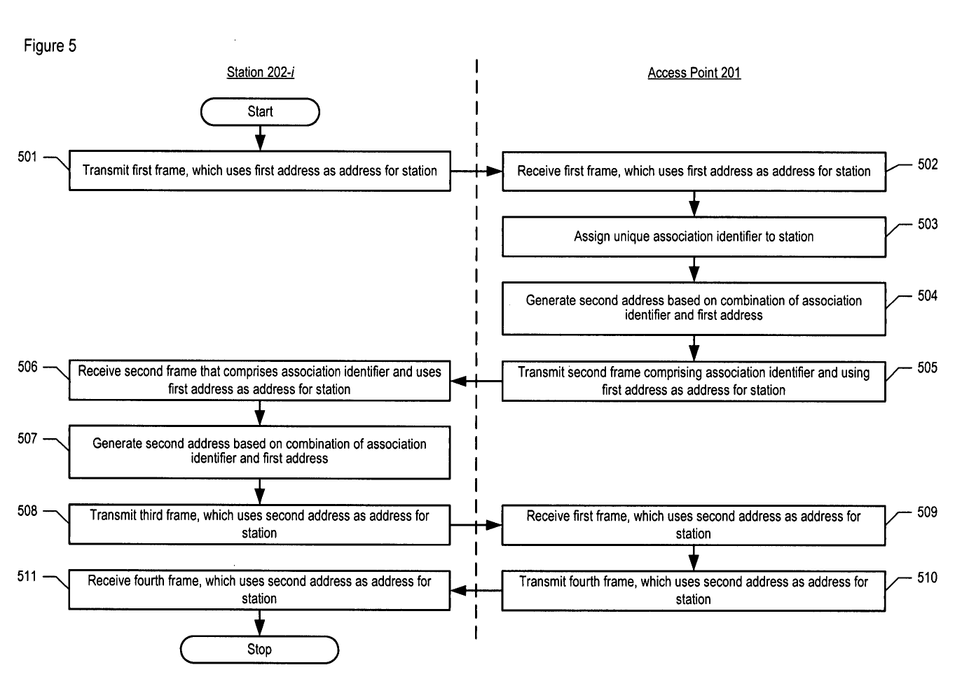

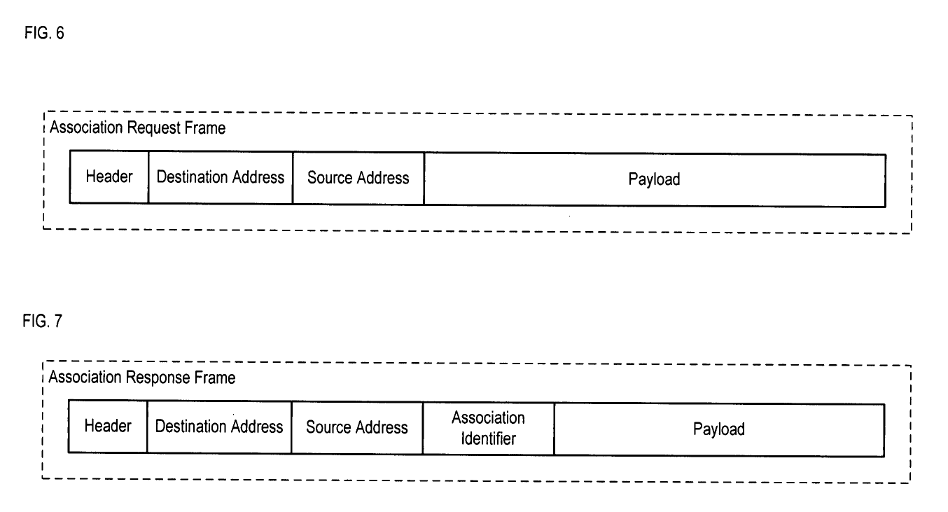

Processor 302 is a general-purpose processor that is capable of performing the tasks described below and with respect to FIG. 5. It will be clear to those skilled in the art, after reading this specification, how to make and use processor 302.

Memory 303 is capable of storing programs and data used by processor 302. It will be clear to those skilled in the art how to make and use memory 303.

Transmitter 304 is a circuit that is capable of receiving frames from processor 302, in well-known fashion, and of transmitting them on shared communications channel 203. It will be clear to those skilled in the art how to make and use transmitter 304.

FIG. 4 depicts a block diagram of the salient components of station 202-i in accordance with the illustrative embodiment of the present invention. Station 202-i comprises receiver 401-i, processor 402-i, memory 403-i, and transmitter 404-i, interconnected as shown.

Receiver 401-i is a circuit that is capable of receiving frames from shared communications channel 203, in well-known fashion, and of forwarding them to processor 402-i. It will be clear to those skilled in the art how to make and use receiver 401-i.

Processor 402-i is a general-purpose processor that is capable of performing the tasks described below and with respect to FIG. 5. It will be clear to those skilled in the art, after reading this specification, how to make and use processor 402-i.

Memory 403-i is capable of storing programs and data used by processor 402-i. It will be clear to those skilled in the art how to make and use memory 403-i.

Transmitter 404-i is a circuit that is capable of receiving frames from processor 402-i, in well-known fashion, and of transmitting them on shared communications channel 203. It will be clear to those skilled in the art how to make and use transmitter 404-i.

FIG. 5 depicts a flowchart of the operation of the illustrative embodiment of the present invention.

At task 601, the process begins whenever station 202-i associates or reassociates with local area network 200. As part of task 601, station 202-i generates a random 46-bit string and provisionally adopts that string as its medium access control address for use in local area network 200. The string is pseudo-randomly generated, but with two important requirements.

In accordance with the first requirement, the string must not be readily predictable by an outside observer. If the value of the string were readily predictable by an outside observer, the string would implicitly reveal the identity of station 202-i, which negates one reason for practicing the invention.

In accordance with the second requirement, the strings generated by each pair of stations must be statistically independent (i.e., uncorrelated). If the strings generated by each pair of stations were uncorrelated, then stations that happen to choose the same, duplicate string, might choose subsequent duplicate strings in lockstep.

It will be clear to those skilled in the art how to generate a pseudo-random number with the two specified requirements. Furthermore, it will be clear to those skilled in the art, after reading this specification, how to make and use alternative embodiments of the present invention in which the string is generated randomly, through a look-up table, or in accordance with another technique. And still furthermore, it will be clear to those skilled in the art, after reading this specification, how to make and use embodiments of the present invention in which the strings have a length of other than 46 bits.

As further part of task 501, station 202-i transmits an “association request” frame to access point 201 with the globally-unique address of access point 201 in the 48-bit destination address field of the frame and a first address in the 48-bit source address field of the frame. The first bit (in the order or transmission via shared-communications channel 200) of the 48-bit first address is 0, which means the frame is a unicast message. The second bit (in the order or transmission via shared-communications channel 200) of the 48-bit first address is 1, which means that the first address is a locally-administered, in contrast to a globally-administered, address. The remaining 46 bits of the first address are populated with the 46-bit string that was generated as described above.

It will be clear to those skilled in the art, after reading this specification, how to make and use alternative embodiments of the present invention that use a frame other than the association request frame in task 501 and 502. Furthermore, it will be clear to those skilled in the art, after reading this specification, how to make and use embodiments of the present invention that have other than a 48-bit address length.

At task 502, access point 201 receives the association request frame with the first address in the source address field of the frame. If the first address matches that of a station that is already associated with local area network 200, then access point 201 assumes that the association attempt is from a station that has generated an address that is identical to the address of a currently associated station (i.e., a duplicate address), and, therefore, access point 201 rejects the request for association. In contrast, if the first address does not match that of a station that is already associated with local area network 200 (i.e., the address is not a duplicate), then control proceeds to task 503.

At task 503, access point 201 assigns an association identifier to station 202-i. The association identifier is an 11-bit string that is unique among the stations that are currently active in local area network 200. It will be clear to those skilled in the art how to assigns an association identifier to station 202-i. Furthermore, it will be clear to those skilled in the art, after reading this specification, how to make and use embodiments of the present invention that use an association identifier with a length other than 11 bits.

At task 504, access point 201 generates a 48-bit second address for station 202-i. The first bit (in the order or transmission via shared-communications channel 200) of the 48-bit first address is 0, which means the frame is a unicast message. The second bit (in the order or transmission via shared-communications channel 200) of the 48-bit first address is 1, which means that the first address is a locally-administered, in contrast to a globally-administered, address. The remaining 46 bits of the first address are populated by combining the 11-bit association identifier assigned in task 503 with 35 bits of the 46-bit string contained in the source address of the association request string. After task 504, access point 201 uses the second address, rather than the first address, as the locally-administered address of station 202-i for the remainder of its association with local area network 200.

By using a unique association identifier in the second address, access point 201 guarantees that the second address is unique among the addresses of the stations in local area network 200 even when the remaining bits in the second address are identical. It will be clear to those skilled in the art, after reading this specification, how to make and use embodiments of the present invention in which the second address is any combination of all or a portion of the association identifier and a portion of the first address. When the second address uses only a portion of the association identifier, that portion of the association identifier should be unique among all of the stations in the local area network to ensure that the second addresses for each station are unique in the local area network.

At task 505, access point 201 transmits an “association response” frame to station 202-i with the 48-bit first address in the destination address field, its 48-bit globally-unique address in the source address field, and the 11-bit association identifier in an association identifier field.

At task 506, station 202-i receives the association response frame with the 48-bit first address in the destination address field, the access point's 48-bit globally-unique address in the source address field, and the 11-bit association identifier in the association identifier field.

At task 507, station 202-i generates the 48-bit second address in accordance with task 504 as performed by access point 201, and thereafter uses the second address, rather than the first address, as its locally-administered address for the remainder of its association with local area network 200.

At task 508, station 202-i transmits a third frame to access point 201 with the globally-unique address of access point 201 in the 48-bit destination address field of the frame and the second address, as generated in task 507, in the 48-bit source address field of the frame.

At task 509, access point 201 receives the third frame with the second address in the source address field of the frame. Because access point 201 generated the second address in task 504 and thereafter associated the second address with station 202-i, access point 201 accepts the frame, associates it with station 202-i, and processes it accordingly.

At task 510, access point transmits a fourth frame to station 202-i with the 48-bit second address in the destination address field.

At task 511, station 202-i receives the fourth frame from access point 201 with the 48-bit second address in the destination address field.

It is to be understood that the above-described embodiments are merely illustrative of the present invention and that many variations of the above-described embodiments can be devised by those skilled in the art without departing from the scope of the invention. It is therefore intended that such variations be included within the scope of the following claims and their equivalents.

1. A method comprising:
receiving a first frame from a station in a local area network, wherein said first frame uses a first address as the medium access control address for said station in said local area network;
assigning an association identifier to said station;
transmitting a second frame to said station via said local area network, wherein said second frame comprises said association identifier and uses said first address as the medium access control address for said station in said local area network; and
receiving a third frame from said station via said local area network, wherein said third frame uses a second address, rather than said first address, as the medium access control address for said station in said local area network;
wherein said second address is a combination of (1) a portion of said first address and (2) at least a portion of said association identifier.

2. The method of claim 1 wherein said association identifier is unique among the stations that are currently active in said local area network.

3. The method of claim 1 further comprising transmitting a fourth frame to said station via said local area network, wherein said fourth frame uses said second address as the medium access control address for said station in said local area network.

4. The method of claim 1 wherein said association identifier is 11 bits in length.

5. The method of claim 1 wherein said first address is 48 bits in length.

6. A method comprising:
transmitting a first frame from a station in a local area network, wherein said first frame uses a first address as the medium access control address for said station in said local area network;
receiving a second frame from at said station via said local area network, wherein said second frame comprises an association identifier and uses said first address as the medium control access address for said station in said local area network;
transmitting a third frame from said station via said local area network, wherein said third frame uses a second address, rather than said first address, as the medium access control address for said station in said local area network;
wherein said second address is a combination of (1) a portion of said first address and (2) at least a portion of said association identifier.

7. The method of claim 6 wherein said association identifier is unique among the stations that are currently active in said local area network.

8. The method of claim 6 further comprising receiving a fourth frame at said station via said local area network, wherein said fourth frame uses said second address as the medium access control address for said station in said local area network.

9. The method of claim 6 wherein said association identifier is 11 bits in length.

10. The method of claim 6 wherein said first address is 48 bits in length.

11. An apparatus comprising:
(1) a receiver for:
(i) receiving a first frame from a station in a local area network, wherein said first frame uses a first address as the medium access control address for said station in said local area network, and
(ii) receiving a third frame from said station via said local area network, wherein said third frame uses a second address, rather than said first address, as the medium access control address for said station in said local area network;
(2) a processor for assigning an association identifier to said station; and
(3) a transmitter for:
(i) transmitting a second frame to said station via said local area network, wherein said second frame comprises said association identifier and uses said first address as the medium access control address for said station in said local area network;
wherein said second address is a combination of (1) a portion of said first address and (2) at least a portion of said association identifier.

12. The apparatus of claim 11 wherein said association identifier is unique among the stations that are currently active in said local area network.

13. The apparatus of claim 11 wherein said transmitter is also for (ii) transmitting a fourth frame to said station via said local area network, wherein said fourth frame uses said second address as the medium access control address for said station in said local area network.

14. The apparatus of claim 11 wherein said association identifier is 14 bits in length.

15. The apparatus of claim 11 wherein said first address is 48 bits in length.

16. An apparatus comprising:
(1) a transmitter for:
(i) transmitting a first frame from a station in a local area network, wherein said first frame uses a first address as the medium access control address for said station in said local area network, and
(ii) transmitting a third frame from said station via said local area network, wherein said third frame uses a second address, rather than said first address, as the medium access control address for said station in said local area network; and
(2) a receiver for:
(i) receiving a second frame from at said station via said local area network, wherein said second frame comprises an association identifier and uses said first address as the medium control access address for said station in said local area network;
wherein said second address is a combination of (1) a portion of said first address and (2) at least a portion of said association identifier.

17. The apparatus of claim 16 wherein said association identifier is unique among the stations that are currently active in said local area network.

18. The apparatus of claim 16 wherein said receiver is further for (ii) receiving a fourth frame at said station via said local area network, wherein said fourth frame uses said second address as the medium access control address for said station in said local area network.

19. The apparatus of claim 16 wherein said association identifier is 11 bits in length.

20. The apparatus of claim 16 wherein said first address is 48 bits in length.
